(19) United States
(12) Patent Application Publication
(10) Pub. No.: US 2005/0097620 A1
(43) Pub. Date: May 5, 2005

(54) Architecture for multi-channel video processing

(75) Inventor: James C. Fye, Scottsdale, AZ (US)

Correspondence Address: Honeywell International Inc.;Law Dept. AB2, P.O. Box 2245, Morristown, NJ, 07962-9806, US

(73) Assignee: Honeywell International Inc.

(21) Appl. No.: 10/699,311

(22) Filed: Oct. 30, 2003

(51) Int. Cl. H04N 7/173; H04N 7/16

(52) U.S. Cl. 725/118; 725/100; 725/131; 725/139; 725/151

(57) ABSTRACT

One embodiment includes an apparatus for display of video data from a designated number of an N number of video channels. The apparatus comprises an N number of video decoders to receive the video data from the N number of video channels. A designated number of the N number of video decoders to decode the video data from the designated number of the N number of video channels. The apparatus also comprises a P number of video processing pipelines coupled to the N number of video decoders through a switch network. The switch network configured to connect any of the outputs from the N number of video decoders to any of the inputs into the P number of video processing pipelines.

### TECHNICAL FIELD

The application relates generally to video processing, more particularly, to an architecture for multi-channel video processing.

### BACKGROUND

With a growing need for real time situational awareness in different types of applications comes a growing need for robust display of multiple simultaneous video channels. One such example is for multiple video displays in aircraft for safety, security, enhanced vision, moving maps, etc. Typically, a system that renders multiple simultaneous analog video channels in real time will simply implement an analog video multiplexer at the front end of the video processing pipeline. Such a system has a “divide-by-n” type of degraded frame rate performance. The degradation of the video display may become very evident when four or more simultaneous analog video channels are to be displayed.

A typical synchronized “n” channel analog video rendering system (displaying “n” video channels simultaneously) displays the video at a degraded frame update rate of “30 Hertz (Hz)/n” for the National Television Standards Committee (NTSC) analog video format standard (60 Hz interlaced fields, 30 Hz frame updates). A typical synchronized “n” channel analog video rendering system (displaying “n” video channels simultaneously) displays the video at a degraded frame update rate of “25 Hz/n” for the Phase Alternating Line (PAL)/Systeme Electronique Couleur Avec Memoire (SECAM) (sequential color with memory) analog video format standard (50 Hz interlaced fields, 25 Hz frame updates).

A typical unsynchronized “n” channel analog video rendering system may be at least two to three times slower because of the (dead) time needed for the video decoder to lock on to the incoming analog video signal. For example, a typical four-channel synchronized NTSC system can produce 7.5 Hz frame updates, while an unsychronized NTSC system can easily slow to 3.0 Hz frame updates. An eight-channel NTSC system is even more degraded. In particular, a typical eight-channel synchronized NTSC system can produce 3.75 Hz frame updates, while an unsychronized NTSC system can easily slow to 1.5 Hz frame updates.

### SUMMARY

Methods, apparatuses and systems for an architecture for multi-channel video processing are described. Embodiments of the invention provide a scalable architecture that enhances the display of multiple simultaneous video channels in real time. Furthermore, embodiments of the invention enable the detection and display of individual failed video channels along with an operation to recover a passing video channel that has been in a failed state. Embodiments of the invention also allow for improved unsynchronized video system update rates by using video scaling field processing for image sizes.

One embodiment includes an apparatus for display of video data from a designated number of an N number of video channels. The apparatus comprises an N number of video decoders to receive the video data from the N number of video channels. A designated number of the N number of video decoders to decode the video data from the designated number of the N number of video channels. The apparatus also comprises a P number of video processing pipelines coupled to the N number of video decoders through a switch network. The switch network configured to connect any of the outputs from the N number of video decoders to any of the inputs into the P number of video processing pipelines.

An embodiment includes a method for displaying video data from N number of video channels in a display. The method includes decoding, with N number of video decoders, a part of video data received in N number of video channels. Additionally, the method includes inputting the decoded part of the video data into P number of video processing pipelines through a non-blocking switch network. The method also includes processing, by the P number of video processing pipelines, the decoded part of the video data in the N number of video channels.

### BRIEF DESCRIPTION OF THE DRAWINGS

Embodiments of the invention may be best understood by referring to the following description and accompanying drawings which illustrate such embodiments. The numbering scheme for the Figures included herein are such that the leading number for a given reference number in a Figure is associated with the number of the Figure. For example, a system 100 can be located in FIG. 1. However, reference numbers are the same for those elements that are the same across different Figures. In the drawings:

FIG. 1 illustrates a system that provides a scalable architecture for multi-channel video processing, according to one embodiment of the invention.

FIG. 2 illustrates a more detailed block diagram of a video logic, according to one embodiment of the invention.

FIGS. 3A-3D illustrate one example of selection and control of video data being inputted into video processing pipelines, according to one embodiment of the invention.

FIG. 4 illustrates a flow diagram for multi-channel video processing, according to one embodiment of the invention.

FIG. 5 illustrates a flow diagram for processing of video data by one of a P number of video processing pipelines, according to one embodiment of the invention.

### DETAILED DESCRIPTION

Methods, apparatuses and systems for an architecture for multi-channel video processing are described. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that embodiments of the invention may be practiced without such specific details. In other instances, control structures, gate level circuits and full software instruction sequences have not been shown in detail in order not to obscure the embodiments of the invention. Those of ordinary skill in the art, with the included descriptions will be able to implement appropriate functionality without undue experimentation.

As described in more detail below, in one embodiment, full video frame update rates may be achieved. Moreover, failed video sources may be flagged in real time. Embodiments of the invention support scalability of multiple video processing pipelines to achieve up to full (e.g., 30 Hertz (Hz)/25 Hz) analog video frame rate performance on a graphic display (such as an Red Green Blue (RGB) display) when displaying N video channels simultaneously. In one embodiment, N video channels are processed by N video decoders to reduce the “dead” time associated with locking onto the analog video signals.

In an embodiment, a user may input a designated number of the N number of video channels to view as well as the window size and location for viewing such channels. Accordingly, embodiments of the invention dynamically may determine the individual image size and location for each of the viewable video channels. Such a determination may be used by video scalers and P number of video processing pipelines to dynamically support changing the number of viewable video images and their respective sizes. Further, embodiments of the invention may include a dispatch/control logic and a completion logic to control the multiple video processing pipelines (including the order in which the decoded video data from the different video decoders is processed).

In one embodiment, a number of the operations described herein are implemented in a field programmable gate array (FPGA). Therefore, depending on the number of logic gates available therein, the number of video processing pipelines may be scaled to N to equal the number of video decoders and video channels. In an embodiment, a non-blocking switch network connects the output from the N number of video decoders to the P number of video processing pipelines (when N does not equal P). In addition, in one embodiment, the outputs of the video processing pipelines are stored in a video buffer. In an embodiment, a write bandwidth of the video buffer is sized to keep up in time with the processing by the P number of video processing pipelines. A write interleaving multiplexer may be coupled to the P number of video processing pipelines to store such outputs into the video buffer. In one embodiment, a clock multiplier network operates at a rate to process the number of pipelines coupled thereto. For example, in an embodiment, a clock multiplier network operating at a rate of at least P/2 controls the rate of operation of the write interleaving multiplexer.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Embodiments of the invention include features, methods or processes embodied within machine-executable instructions provided by a machine-readable medium. A machine-readable medium includes any mechanism which provides (i.e., stores and/or transmits) information in a form accessible by a machine (e.g., a computer, a network device, a personal digital assistant, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include software, data processing hardware, data processing system-implemented methods, and various processing operations, further described herein.

A number of figures show block diagrams of systems and apparatus for an architecture for multi-channel video processing, in accordance with embodiments of the invention. A number of figures show flow diagrams illustrating operations for an architecture for multi-channel video processing. The operations of the flow diagrams will be described with references to the systems/apparatuses shown in the block diagrams. However, it should be understood that the operations of the flow diagrams could be performed by embodiments of systems and apparatus other than those discussed with reference to the block diagrams, and embodiments discussed with reference to the systems/apparatus could perform operations different than those discussed with reference to the flow diagrams.

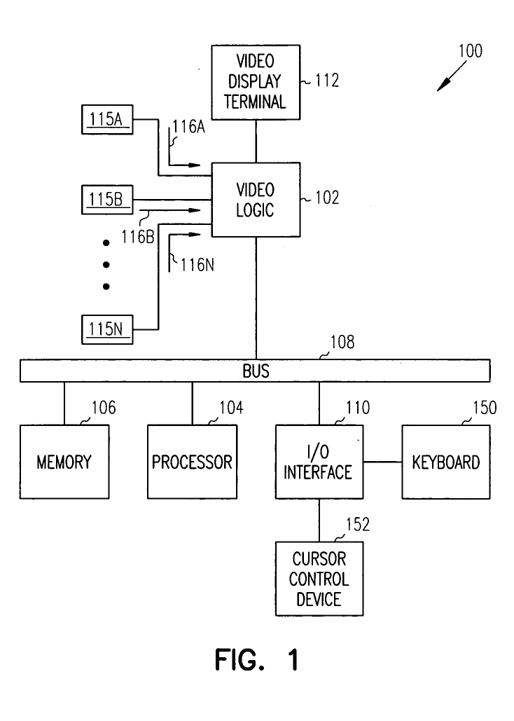

FIG. 1 illustrates a system that provides a scalable architecture for multi-channel video processing, according to one embodiment of the invention. FIG. 1 illustrates a system 100 that includes a video logic 102, a processor 104, a memory 106, input/output (I/O) interface 110, a video display terminal 112, a bus 108, a number of video sources 115A-115N, a keyboard 150 and a cursor control device 152. The video logic 102, the processor 104, the memory 106 and the I/O interface 110 are coupled together through the bus 108.

The memory 106 may be different types of RAM (e.g., Synchronous Dynamic RAM (SDRAM), DRAM, Double Data Rate (DDR)-SDRAM, etc.), while in one embodiment, the processor 104 may be different types of general purpose processors. The I/O interface 110 provides an interface to I/O devices or peripheral components for the system 100. The I/O interface 110 may comprise any suitable interface controllers to provide for any suitable communication link to different components of the system 100. The I/O interface 110 for one embodiment provides suitable arbitration and buffering for one of a number of interfaces.

As shown, the I/O interface 110 is coupled to receive input from the keyboard 150 and the cursor control device 152 (e.g., a mouse). Additionally, for one embodiment, the I/O interface 110 provides an interface to one or more suitable integrated drive electronics (IDE) drives, such as a hard disk drive (HDD) or compact disc read only memory (CD ROM) drive for example, to store data and/or instructions, for example, one or more suitable universal serial bus (USB) devices through one or more USB ports, an audio coder/decoder (codec), and a modem codec. The I/O interface 110 for one embodiment also provides an interface to a printer through one or more ports. The I/O interface 110 may also provide an interface to one or more remote devices over one of a number of communication networks (the Internet, an Intranet network, an Ethernet-based network, etc.).

The number of video sources 115A-115N are coupled to the video logic 102. While the video logic 102 may be software, hardware and/or a combination thereof, in one embodiment, the video logic 102 is a field programmable gate array. The video logic 102 is coupled to the video display terminal 112. The number of video sources 115A-115N generate video data in video channels 116A-116N, respectively. In an embodiment, the video sources 115A-115N may be different types of video cameras. As described in more detail below, the video data in the video channels 116A-116N are inputted into the video logic 102. The video logic 102 decodes and renders the video data across the number of different video channels 116A-116N onto the video display terminal 112. As described in more detail below, the video logic 102 includes a scalable architecture for multi-channel video processing.

In one embodiment, a user of the system 100 may control which of the number of video channels 116A-16N are to be viewed in a window of the video display terminal 112. Moreover, the user may control the size and/or the location of such window in the video display terminal 112.

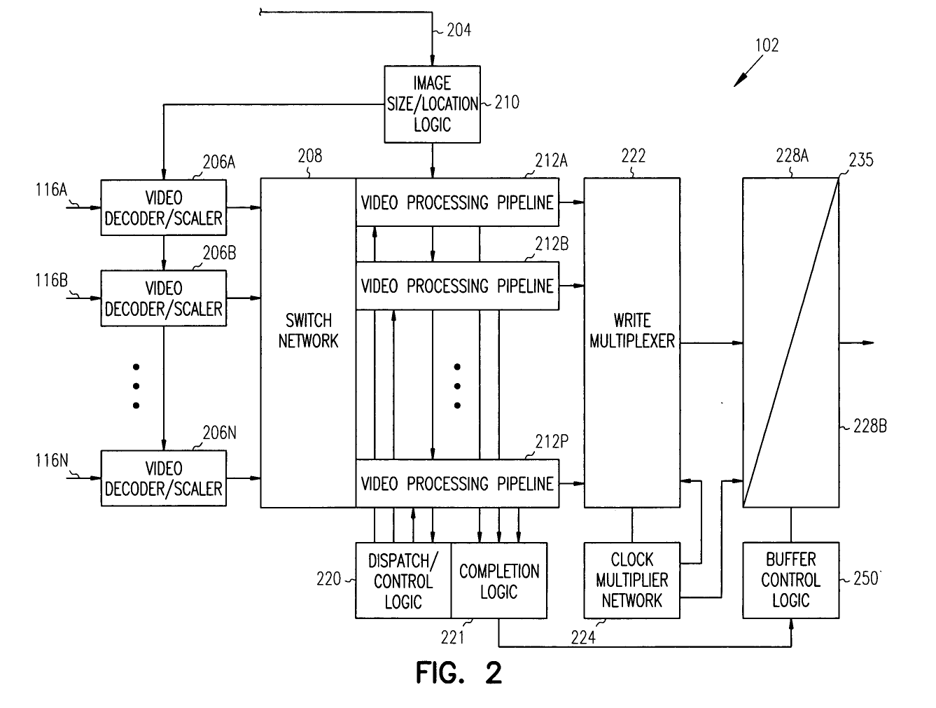

To illustrate, a more detailed description of one embodiment of the video logic 102 is now described. In particular, FIG. 2 illustrates a more detailed block diagram of a video logic, according to one embodiment of the invention. As shown, the video logic 102 includes a N number of video decoders/scalers 206A-206N, an image size/location logic 210, a switch network 208, a P number of video processing pipelines 212A-212P, a dispatch/control logic 220, a completion logic 221, a write multiplexer 222, a clock multiplier network 224, a buffer control logic 250 and a video buffer 235 (that includes a first buffer 228A and a second buffer 228B). While FIG. 2 illustrates the scaler being incorporated into the video decoder/scaler 206, embodiment of the invention are not so limited. In another embodiment, the scaler is part of the video processing pipelines 212A-212P.

The N number of video decoders/scalers 206A-206N are coupled to receive the N number of video channels 116A-116N, respectively. The video decoder/scaler 206A is coupled to receive the video channel 116A; the video decoder/scaler 206B is coupled to receive the video channel 116B; the video decoder/scaler 206N is coupled to receive the video channel 116N, etc. In one embodiment, each of the N number of video channels 116A-116N is a channel of analog video. While described such that there is a one-to-one relationship between the N number of video decoders/scalers 206A-206N and the N number of video channels 116A-116N, embodiments of the invention are not so limited. For example, in an embodiment, more than one video channel 116 may be coupled to a given video decoder/scaler 206. A multiplexer may be coupled there between to allow for sharing of the given video decoder/scaler 206.

In an embodiment, each of the video decoders/scalers 206A-206N receives analog data in the video channels 116A-116N and converts such data into digital data in the YUV color space. Moreover, as described in more detail below, each of the video decoders/scalers 206A-206N may scale the frames of converted digital data into a different size. For example, assume that four images from four different video channels 116A-116N have a resolution of 720×480 and that such images are to be equally displayed on a display having a resolution of 800×600 (a 400×300 resolution image for each of the four images). Accordingly, the video decoders/scalers 206A-206N scale the 720×480 resolution image down to a resolution of 400×300. The image size/location logic 210 is coupled to each of the video decoders/scalers 206A-206N. As further described below, in one embodiment, the image size/location logic 210 controls whether scaling is performed as well as the amount of the scaling of an image.

The outputs from the video decoders/scalers 206A-206N are inputted into the switch network 208. As further described below, the switch network 208 may couple any of the outputs from the video decoders/scalers 206A-206N to any of the P number of video processing pipelines 212A-212P. In one embodiment, N equals P. Accordingly, the number of video decoders/scalers 206A-206N (and the number of video channels 116A-116N) equals the number of video processing pipelines 212A-212P. In one such embodiment, the switch network 208 is not needed. In an embodiment, the switch network 208 is non-blocking. In other words, the switch network 208 may route any output from one of the video decoders/scalers 206 to any one of the video processing pipelines 212 at any point in time.

Each of the video processing pipelines 212A-212P includes logic to process the decoded video received from the video decoders/scalers 206A-206N. Such logic may include video lock detection, YUV to RGB color space conversion, Gamma LUT correction, etc.

The image size/location logic 210 is coupled to receive a control signal 204. In an embodiment, the control signal 204 are instructions from the processor 104 (of the system 100) based on user input received through an I/O device coupled to the I/O interface 110. For example, if the system 100 is incorporated into a cockpit for display of a number of different video, the pilot may input which camera views are to be displayed via an I/O device such as the keyboard 150 and/or the cursor control device 152.

The control signal 204 includes the video window size/location in the video display terminal 112 and the video sources that are viewable. The video window size may be a full-screen size selection or a partial screen selection. Moreover, the selection of the currently viewable number of video sources to be displayed within that view port should be one to any combination of all of the video channels available. As described above, to support this flexibility, a scaler logic within the video decoders/scalers 206 scales the incoming video streams to the correct 4:3 format necessary to fit the designated number of video sources into the designated video view port display area.

To illustrate, if the system 100 is within a cockpit, the pilot may have eight different cameras for viewing. However, the pilot may select only three of the eight different cameras. Subsequently, the pilot may modify the video window size/location and/or the video sources that are viewable. Accordingly, the control signal 204 with such new parameters is inputted into the image size/location logic 210. Based on the new parameters, the image size/location logic 210 outputs different values to the video decoders/scalers 206A-206N, the video processing pipelines 212A-212P and the dispatch/control logic 220.

As further described below, the image size/location logic 210 generates an individual image location/size for each video source currently designated for viewing so that the video rendering operation may correctly locate each image on the video display terminal 112. Therefore, this output of the image size/location logic 210 is coupled to each of the video decoders/scalers 206A-206N, to each of the video processing pipelines 212A-212P and to the dispatch/control logic 220.

The dispatch/control logic 220 is coupled to the video processing pipelines 212A-212P. The dispatch/control logic 220 outputs control signals to the video processing pipelines 212A-212P to indicate whether and which digital data (outputted from the video decoders/scalers 206) are to be processed. Each of the video processing pipelines 212A-212P are coupled to the completion logic 221. As further described below, a video processing pipeline 212 outputs a control signal to the completion logic 221 that indicates when the given video processing pipeline 212 has completed processing a given frame of video data.

In a given cycle, for the different video sources that are to be displayed (based on the control signal 204), the video processing pipelines 212A-212P process one frame of data from each of said video sources. Subsequently, the video processing pipeline 212 that processed the frame of data outputs an indication to the completion logic 221 that this operation is complete. This same video processing pipeline 212 may process a frame of data from a different video source. For example, if there are eight different designated video sources from eight different video channels and only two different video processing pipelines 212, such pipelines process frames of data from multiple video channels in a given cycle. Accordingly, a cycle is considered completed after a frame of data from each of the designated video sources has been processed by the video processing pipelines 212. Therefore, the video processing pipelines 212A-212P continue processing the data from the designated video sources until a frame of data has been processed from each of said designated sources.

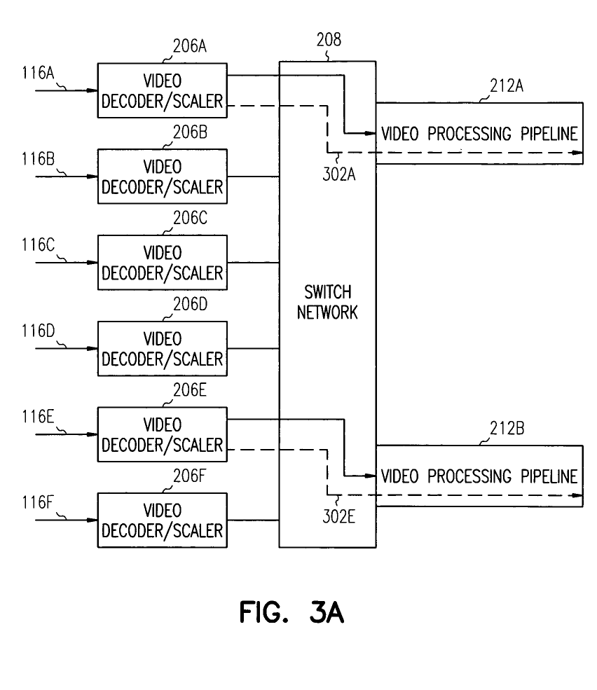

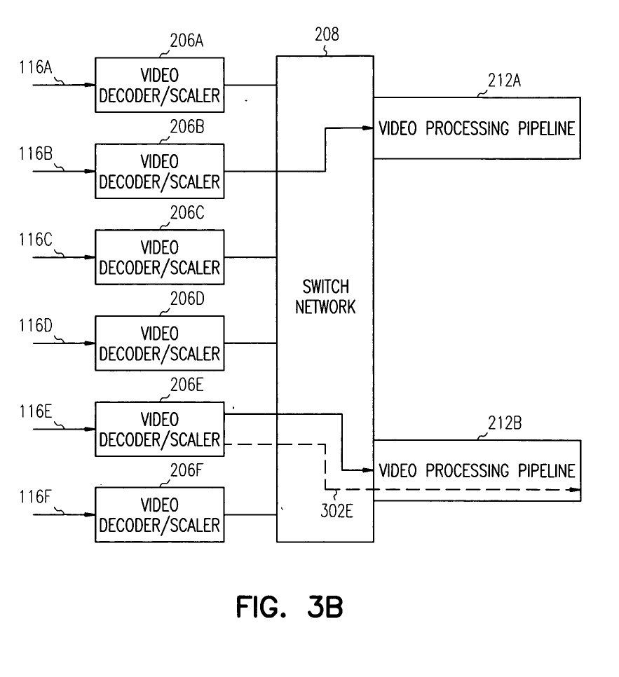

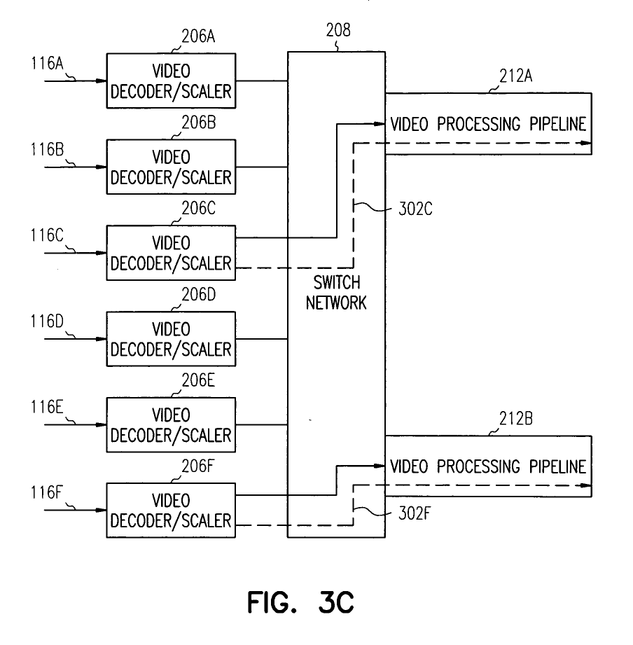

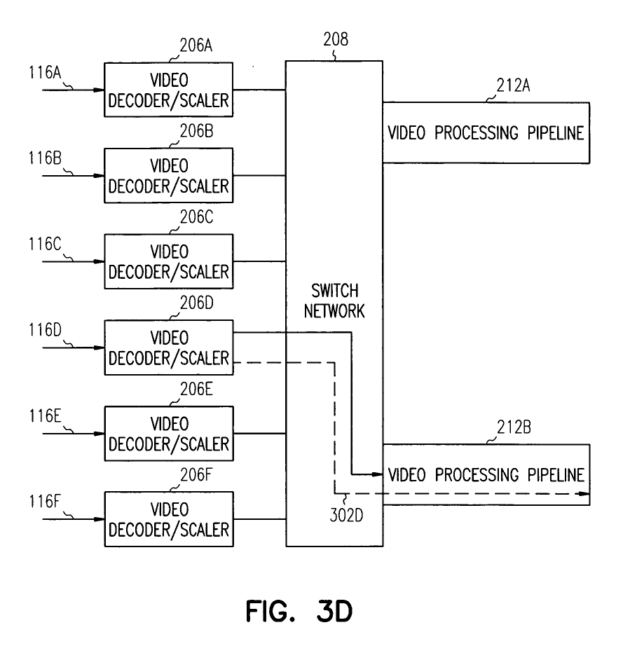

The completion logic 221 is coupled to the dispatch/control logic 220. Accordingly, when a given video processing pipeline 212 has completed processing a frame of data from a given video source, if there are video sources for which a frame of data has not been processed, the dispatch/control logic 220 outputs an indication to this video processing pipeline 212 of a different video decoder/scaler 206 for which a frame of data has not been processed. An example of such operations of the video processing pipelines 212A-212P is described in more detail below in conjunction with FIG. 3A-3D.

Each of the video processing pipelines 212A-212P are coupled to the write multiplexer 222. The write multiplexer 222 is coupled to the video buffer 235. The write multiplexer 222 stores results of the processing of a frame of data (received from the video processing pipelines 212A-212P) into either the first buffer 228A or the second buffer 228B. In particular, the video buffer 235 is segregated into two different buffers, which is acting as a ping pong buffer. If the first buffer 228A is being written to by the video processing pipelines 212A-212P, the second buffer 228B is being read for display of the video data stored therein onto the video display terminal 112. When all of the frames of data for the different designated video data channels have been written into the first frame buffer 228 for a given cycle, the first buffer 228A and the second buffer 228B are switched. Accordingly, the second buffer 228B is then being written to by the video processing pipelines 212A-212P, while the first buffer 228A is being read for display of the video data stored therein onto the video display terminal 112.

The completion logic 221 is coupled to the buffer control logic 250. The completion logic 221 provides an indication to the buffer control logic 250 that all of the frames of data for a given cycle have been processed. Accordingly, the buffer control logic 250 switches the first buffer 228A and the second buffer 228B, as described above.

Moreover, the clock multiplier network 224 is coupled to the write multiplexer 222 and the video buffer 235. The clock multiplier network 224 controls the rate at which the video data is written to the video buffer 235. In an embodiment, the clock multiplier network 224 causes the write multiplexer 222 to operate at a rate such that write multiplexer 222 may write the results from each of the P video processing pipelines 212. To illustrate, assume that the decoded video data received from the video decoders/scalers 206 is in an eight-bit 4:2:2 YUV color space. Accordingly, a clock rate of the P video processing pipelines 212 would be twice the clock rate required to write 24 bit RBG data into the video buffer 235. Therefore, the clock multiplier network 224 is required to operate at a rate of at least P/2 to drive the write multiplexer 222 to support the needed video RGB frame buffer write data clock rate (bandwidth).

One example of processing of video data from N number of video data channels by P number of video processing pipelines is now described. In particular, FIGS. 3A-3D illustrate one example of selection and control of video data being inputted into video processing pipelines, according to one embodiment of the invention. As shown, FIGS. 3A-3D illustrate six video decoder/scalers 206 (video decoders/scalers 206A-206F) coupled to two video processing pipelines 212 (video processing pipelines 212A-212B) through the switch network 208. FIGS. 3A-3D illustrate the processing of a frame of data from each of six different video channels 116A-116F. The dispatch/control logic 220 (shown in FIG. 2) controls which frame of data that a given video processing pipeline 212 is to process.

FIG. 3A illustrates a first point in time of the video processing. The video decoder/scaler 206A outputs a frame of decoded data 302A and the video decoder/scaler 206E outputs a frame of decoded data 302E. The video processing pipeline 212A processes the frame of decoded data 302A and the video processing pipeline 212B processes the frame of decoded data 302E.

FIG. 3B illustrates a second point in time of the video processing. The video processing pipeline 212A completed processing of the frame of decoded data 302A. The dispatch/control logic 220 couples the output from the video decoder/scaler 206B to the input of the video processing pipeline 212A through the switch network 208. However, as shown, the video decoder/scaler 206B has not output a frame of decoded data, because the video decoder/scaler 206B has not locked onto the analog signal received on the video channel 116B. As further described in more detail below, if the video decoder/scaler 206 is unable to lock onto the analog signal after a predetermined time, the video processing pipeline 212 outputs a frame of data that indicates that the video channel 116 is in a failed state. The video processing pipeline 212B is still processing the frame of decoded data 302E.

FIG. 3C illustrates a third point in time of the video processing. The video processing pipeline 212A completed processing of the video channel 116B. The video decoder/scaler 206B may have locked onto the analog signal, thereby outputting a frame of decoded data for the video processing pipeline 212A to process. However, if the predetermined time period has expired and the video decoder/scaler 206B was unable to lock onto the analog signal, the video processing pipeline 212A output a frame of data that indicates that the video channel 116B is in a failed state. In either situation, the video processing pipeline 212A completed processing of the video channel 116B.

The dispatch/control logic 220 couples the output from the video decoder/scaler 206C to the input of the video processing pipeline 212A through the switch network 208. Moreover, as shown, at this point in time, the video decoder/scaler 206C has locked onto the analog signal for the video channel 116 and is outputting a frame of decoded data 302C to be processed by the video processing pipeline 212A.

Also as shown, the video processing pipeline 212B completed processing of the video channel 116E. Moreover, the dispatch/control logic 220 has coupled the output from the video decoder/scaler 206F to the input of the video processing pipeline 212B through the switch network 208. Furthermore, as shown, at this point in time, the video decoder/scaler 206F has locked onto the analog signal for the video channel 116F and is outputting a frame of decoded data 302F to be processed by the video processing pipeline 212B.

FIG. 3D illustrates a fourth point in time of the video processing. The video processing pipeline 212B completed processing of the frame of decoded data 302F. Moreover, the dispatch/control logic 220 has coupled the output from the video decoder/scaler 206D to the input of the video processing pipeline 212B through the switch network 208. Furthermore, as shown, at this point in time, the video decoder/scaler 206D has locked onto the analog signal for the video channel 116D and is outputting a frame of decoded data 302D to be processed by the video processing pipeline 212B.

The video processing pipeline 212A completed processing of the frame of decoded data 302C. The video channel 116D was the one remaining video channel unprocessed in this cycle. Therefore, the video processing pipeline 212A remains idle after completing processing of the video channel 116C.

Returning to FIG. 2, once the video processing pipeline 212B has completed processing, the completion logic 221 will have receive indications that frames of data from all of the video sources that are to be displayed on the video display terminal 112 have been processed. Accordingly, the processed frames of data 302 have been written to the video buffer 235. The completion logic 221 then transmits an indication to the buffer control logic 250 that the first buffer 228A and the second buffer 228B may be switched. Therefore, the newly processed frames of data 302 can then be displayed onto the video display terminal 112.

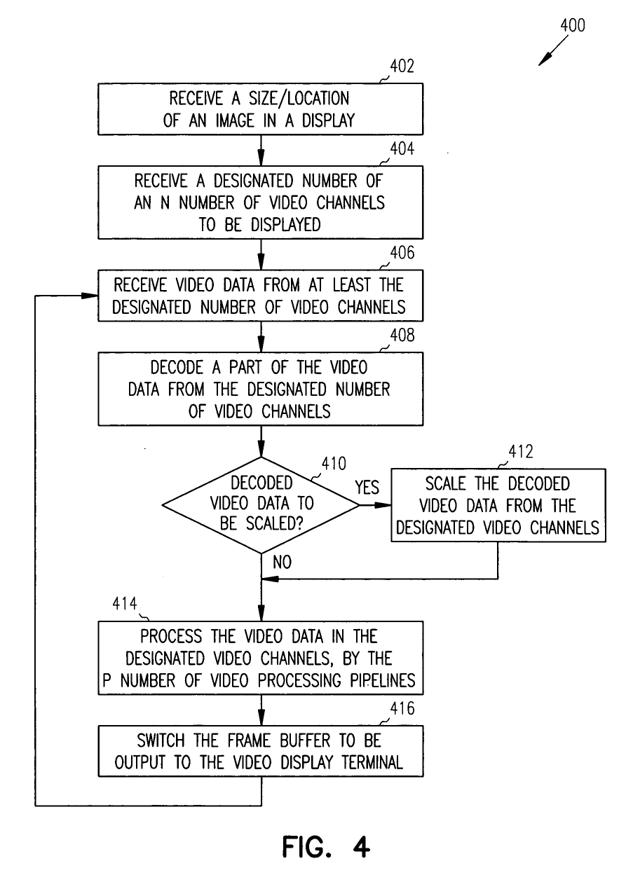

One embodiment of the operations of the video logic 102 are now described with reference to flow diagrams illustrated in FIGS. 4-6. FIG. 4 illustrates a flow diagram for multi-channel video processing, according to one embodiment of the invention.

In block 402 of the flow diagram 400, a size and a location of an image in a display is received. With reference to the embodiment of FIG. 2, the image size/location logic 210 receives the control signal 204 that includes the size and the location of the image to be displayed on the video display terminal 112. The size of the image may be a full or partial-screen size in reference to the video display terminal 112. Moreover, if the size of the image is a partial-screen size, the location of the image on the video display terminal 112 is also received. For example, if the system 100 is used in cockpit of an airplane, the pilot may designate such input through a keyboard, voice input, etc. Control continues at block 404.

In block 404, a designated number of an N number of video channels to be displayed in the image is received. With reference to the embodiment of FIG. 2, the image size/location logic 210 receive the control signal 204 that includes the designated number of the N number of video channels 116A-16N that are to be displayed in the image (described in block 402). Accordingly, a user of the system 100 may select less than all of the N number of video channels for viewing, even though N number of video channels are inputting data into the video decoders 206A-206N. Control continues at block 406.

In block 406, video data from at least the designated number of video channels is received. With reference to the embodiment of FIGS. 1 and 2, the video sources 115A-115N output video data through the video channels 116A-116N, respectively. This video data from the video channels 116A-116N is inputted into the video decoders/scalers 206A-206N, respectively. Control continues at block 408.

In block 408, a part of the video data in the at least designated video channels is decoded and/or scaled. With reference to the embodiment of FIG. 2, the video decoders/scalers 206A-206N receive and decode a part of the video data. In an embodiment, the video data is analog data. In one embodiment, the part of the video data that is decoded is a frame of the video data, which may be of varying size depending on the video standard being used to capture the video data. For example, if the NTSC standard is being used the video frames have a resolution of 720×480. In another embodiment, the part of the video data that is decoded is a field in a frame of the video data. For example, the frame of the video data may be segregated into an even field and an odd field. The even field includes the even lines of the frame, while the odd field includes the odd lines of the frame. While the video data may be decoded based on a number of different standards, in one embodiment, the video decoders/scalers 206A-206N decodes the video data into the YUV color space. Control continues at block 410.

In block 410, a determination is made of whether the decoded video data needs to be scaled. With reference to the embodiment of FIG. 2, the video decoders/scalers 206A-206N make this determination. In one embodiment, the video decoders/scalers 206A-206N makes this determination based on the output from the image size/location logic 210. In particular, the image size location logic 210 outputs the size of screen within the image for the designated video channels. For example, assume that the video frames of the video data have a resolution of 720×480, that there are four different designated video signals that are equally displayed on an image having a size of 800×600. Therefore, the image size/location logic 210 outputs a control signal to the video decoders/scalers 206A-206N to scale the frames from 720×480 down to 400×300. Upon determining that the decoded video data does not need to be scaled, control continues at block 414, which is described in more detail below.

In block 412, upon determining that the decoded video data does need to be scaled, the decoded video data is scaled. With reference to the embodiment of FIG. 2, the video decoders/scalers 206A-206N scale the decoded video data. Control continues at block 414.

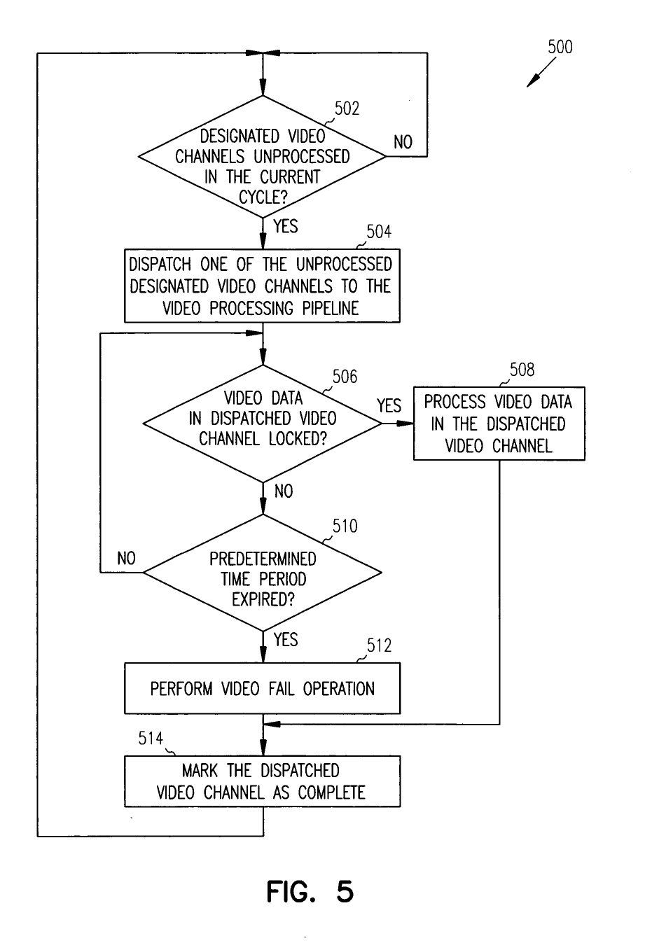

In block 414, the decoded video data for the designated video channels 116 are processed by the P video processing pipelines. With reference to the embodiment of FIG. 2, the dispatch/control logic 220 controls which of the P number of video processing pipelines 212A-212P is to receive the decoded video data (outputted from the different video decoders/scalers 206 that process the video data that are in the designated video channels 116). In particular, as described above in conjunction with FIG. 3A-3D, a frame of decoded video data is inputted into the video processing pipelines 212A-212P based on control signals from the dispatch/control logic 220. The P video processing pipelines 212A-212P process the decoded video data for the designated video channels 116. In one embodiment, one of the P video processing pipelines 212A-212P processes the output from one of the video decoders/scalers 206A-206N. In an embodiment, the P video processing pipeline 212 processes one frame or a field in a frame of the video data that has been decoded. As described above, FIGS. 3A-3D illustrate an example of the order of processing by the P video processing pipelines 212A-212P. As further described below, in one embodiment, if after a predetermined time, the video decoder/scaler 206 that is to decode the video data in the video channel 116 is unable to lock onto and decode the video data, the P video processing pipeline 212 processes the video data by outputting an indication that the video source is in a failed state. One embodiment of the processing by the P video processing pipelines 212A-212P is described in more detail below in conjunction with a flow diagram 500 of FIG. 5.

Additionally, the video processing pipeline 212 that processed the decoded video data stores such data into either the first buffer 228A or the second buffer 228B (depending on which one is currently being written to). The video processing pipeline 212 stores such data into the first buffer 228A or the second buffer 228B though the write multiplexer 222. The write multiplexer 222 allows for the storage of this processed data from the P video processing pipelines 212A-212P at a rate that is controlled by the clock multiplier network 224. The write multiplexer 222 shares access to the first buffer 228A or the second buffer 228B by allowing a first P video processing pipeline 212 to store a given amount of data, then allowing a second P video processing pipeline 212 to store a given amount of data, etc., and then again allowing the first P video processing pipeline 212 to store another given amount of data, etc. Accordingly, the write multiplexer 222 allows for the sharing of the memory bandwidth for the current buffer 228 being written to, as the storage operations by the different video processing pipelines 212A-212P are interleaved. Control continues at block 416.

In block 416, the frame buffer to be output to the video display terminal is switched. With reference to the embodiment of FIG. 1 and FIG. 2, after the part of the video data for a given designated video channel 116 has been processed, the video processing pipeline 212 (that performed the processing) outputs an indication to the completion logic 221 that indicates that this designated video channel 116 is complete. After receiving indications that all of the designated video channels 116 have been completed, the completion logic 221 transmits a completion signal to the buffer control logic 250. The buffer control logic 250 then switches the first buffer 228A and the second buffer 228B (as described above). Control continues at block 406, where a new cycle is initiated for receiving and processing of video data from the designated video channels 116.

The operations of the flow diagram 400 continue until such operations are interrupted by a different input on the control signal 204. For example, if the user modifies the number of video channels to be viewed and/or the size or the location of the window for viewing such video channels, the operations executing within the video logic 102 are interrupted and control continues at block 402 of the flow diagram 400.

One embodiment of the operations of one of the video processing pipelines 212A-212P is now described. In particular, FIG. 5 illustrates a flow diagram for processing of video data by one of a P number of video processing pipelines, according to one embodiment of the invention.

In block 502 of the flow diagram 500, a determination is made of whether designated video channels are unprocessed in the current cycle. With reference to FIG. 2, the dispatch/control logic 220 receives, from the image size/location logic 210, which of the N number of video channels 116A-116N are designated to be viewed in the current window in the video display terminal 112. For example, if there are eight video channels, the user may configure the system 100 such that the first, second, seventh and eighth video channels are to be viewed. Accordingly, the dispatch/control logic 220 receives an indication that these four channels are to be viewed. In one embodiment, a given video processing pipeline 212 processes a part of the video data for a given video data channel for a given cycle. In one embodiment, the part of the video data processed is a frame of the video data. In an embodiment, the part of the video data processed is a field in a frame of the video data. In one embodiment, the part of the video data processed is a scaled field in a frame of the video data.

The dispatch/control logic 220 receives input from the completion logic 221 that indicates when a video processing pipeline 212 has completed processing the part of the video data for a given video channel and is available to process video data for a different video channel. Therefore, after one of the video processing pipelines is available for processing video data for a video channel, the dispatch/control logic 220 determines whether other designated video channels are unprocessed in the current cycle. Upon determining that there are no designated video channels that are unprocessed in the current cycle, control continues at block 502 where this determination is again made.

In block 504, one of the unprocessed designated video channels is dispatched (connected) to the video processing pipeline. With reference to the embodiment of FIG. 2, the dispatch/control logic 220 dispatches (connects) the video decoder/scaler 206 (coupled to the unprocessed designated video channel) to the video processing pipeline 212 (that is available) through the switch network 208. Control continues at block 506.

In block 506, a determination is made of whether the video data in the dispatched video channel is locked. With reference to the embodiment of FIG. 2, a lock detection logic (not shown) internal to the video processing pipeline 212 makes this determination. The video decoder/scaler 206 that decodes the video data locks onto the incoming video data to locate the frames therein. Once locked onto the incoming video data, the video decoder/scaler 206 outputs a lock indicator that is received by the video processing pipeline 212. Accordingly, the lock detection logic makes this determination based on whether the lock indicator has been received.

In block 508, upon determining that the video data in the dispatched video channel is locked, the video data in the dispatched video channel (that has been decoded) is processed. With reference to the embodiment of FIG. 2, the video processing pipeline 212 processes the video data. In an embodiment, the video processing pipeline 212 processes a frame of the video data. In an embodiment, the part of the video data processed is a field in a frame of the video data. In one embodiment, the part of the video data processed is a scaled field in a frame of the video data. In one embodiment, the processing may include YUV to RGB color space conversion and Gamma LUT correction, etc. Control continues at block 514, which is described in detail below.

In block 510, upon determining that the video data in the dispatched video channel is not locked, a determination is made of whether a predetermined time period has expired. With reference to the embodiment of FIG. 2, the lock detection logic (not shown) internal to the video processing pipeline 212 makes this determination. The value of the predetermined time period may be a configurable value that may depend on the application that the system 100 is executing, the number of video sources, etc. Upon determining that the predetermined time period has not expired, control continues at block 506, where the determination is again made of whether the video data in the dispatched video channel is locked.

In block 512, upon determining that the predetermined time period has expired, a video fail operation is performed. With reference to the embodiment of FIG. 2, the video processing pipeline 212 performs the video fail operation. In an embodiment, the video processing pipeline 212 includes two different paths of operation: a process operation path and a failed operation path. The lock detection logic within the video processing pipeline 212 makes the determination on which of the paths is to execute (depending on whether the video data is in a failed state or not).

A number of different operations may be performed to flag failure of the video data. In one embodiment, the video processing pipeline 212 causes the retention of the last image for this video channel with descriptive text (e.g., “VIDEO FAIL”) overlaid on such image. In one embodiment, the video processing pipeline 212 causes this retention of the last image by copying the last image from the buffer 228 (not being written to) to the buffer 228 (being written to) for this video channel.

In another embodiment, the video processing pipeline 212 performs the video fail operation by outputting a blank or a black image for display. In an embodiment, the video processing pipeline 212 performs the video fail operation by outputting a blank or a black image for display with descriptive text (e.g., “VIDEO FAIL”) overlaid on such image. In one embodiment, the video processing pipeline 212 performs the video fail operation by outputting a blank or a black image for display with an “X” overlaid on such image. In an embodiment, the video processing pipeline 212 performs the video fail operation by outputting a blank or a black image for display overlaid with an “X” and descriptive text (e.g., “FAILURE”) overlaid on such image. Control continues at block 514.

In block 514, the dispatched video channel is marked as completed. With reference to the embodiment of FIG. 2, the video processing pipeline 212 marks this dispatched video channel as complete by outputting a completion signal to the completion logic 221. Control continues at block 502, where another determination is made of whether designated video channels are unprocessed in the current cycle.

Accordingly, the operations of the flow diagram 500 continue until the video data for the designated video channels has been processed in the current cycle. Moreover, as described, the determination of whether the video channel is in a failed state is again checked, thereby allowing the video channel to be processed in the next cycle. Therefore, the embodiments of the invention allow for prompt recovery of a nonfailing video source.

Thus, methods, apparatuses and systems for an architecture for multi-channel video processing have been described. Although the present invention has been described with reference to specific exemplary embodiments, it will be evident that various modifications and changes may be made to these embodiments without departing from the broader spirit and scope of the invention. For example, while described with reference to processing of analog data, embodiments of the invention are not so limited. In an embodiment, digital data may be in the video channels being input into the video logic 102 for processing, according to embodiments of the invention. Therefore, the specification and drawings are to be regarded in an illustrative rather than a restrictive sense.

1. An apparatus for display of video data from a designated number of an N number of video channels, the apparatus comprising:
an N number of video decoders to receive the video data from the N number of video channels, a designated number of the N number of video decoders to decode the video data from the designated number of the N number of video channels; and
a P number of video processing pipelines coupled to the N number of video decoders through a switch network, the switch network configured to connect any of the outputs from the N number of video decoders to any of the inputs into the P number of video processing pipelines.

2. The apparatus of claim 1, further comprising an image size/location logic to receive a designated size of a display window and the designated number of the N number of video channels whose video data is to be displayed in the display window, the image size/location logic to determine a location in the display window and a size of a part of the display window for display for the video data for each of the designated number of video channels.

3. The apparatus of claim 2, further comprising N number of scalers, wherein a designated number of the N number of scalers are to scale the decoded video data from the designated number of the N number of video channels based on the determined size of the part of the display window.

4. The apparatus of claim 1, wherein the P number of video processing pipelines are to process the decoded video data of the designated number of the video channel received from the designated number of the N number of video decoders.

5. The apparatus of claim 4, wherein P is less than N and wherein the apparatus further comprises a display/control logic to control a process order of the designated number of the N number of video channels by the P number of video processing pipelines.

6. The apparatus of claim 1, further comprising a write multiplexer to receive the processed decoded video data from the P number of video processing pipelines, the write multiplexer to store the processed decoded video data from the designated number of the N number of video channels into a memory.

7. A method for displaying video data from N number of video channels in a display, the method comprising:
decoding, with N number of video decoders, a part of video data received in N number of video channels;
inputting the decoded part of the video data into P number of video processing pipelines through a switch network; and
processing, by the P number of video processing pipelines, the decoded part of the video data in the N number of video channels.

8. The method of claim 7, wherein P is less than N.

9. The method of claim 7, further comprising storing the processed decoded part of the video data in the N number of video channels into a part of a video buffer that is not updating the display.

10. The method of claim 9, further comprising switching the part of the video buffer that is not updating the display with a part of the video buffer that is updating the display, upon determining that the P number of video processing pipelines has completed processing the decoded part of the video data for each of the N number of video channels.

11. The method of claim 7, wherein decoding, with the N number of video decoders, the part of video data received in the N number of video channels comprises decoding, with the N number of video decoders, a frame in the video data received in the N number of video channels.

12. The method of claim 7, wherein decoding, with the N number of video decoders, the part of video data received in the N number of video channels comprises decoding, with the N number of video decoders, a field of a frame in the video data received in the N number of video channels.

13. The method of claim 7, wherein decoding, with the N number of video decoders, the part of video data received in the N number of video channels comprises decoding, with the N number of video decoders, a scaled field of a frame in the video data received in the N number of video channels.

14. A method comprising:
receiving an image size and a location in a display;
receiving a designated number of an N number of video channels to be displayed in the image; and
performing the following for each of the designated number of the N number of video channels:
decoding, with one of an N number of video decoders, a frame of video data received in the video channel;
inputting the decoded frame into one of a P number of video processing pipelines through a non-blocking switch network;
processing, by the one of the P number of video processing pipelines, the decoded frame; and
storing the processed decoded frame into a part of a video buffer that is not updating the display.

15. The method of claim 14, wherein processing, by the one of the P number of video processing pipelines, the decoded frame comprises determining whether the video channel is in a failed state.

16. The method of claim 15, wherein processing, by the one of the P number of video processing pipelines, the decoded frame comprises outputting a blacked out frame for the video channel upon determining that the video channel is in a failed state.

17. The method of claim 14, further comprising switching the part of the video buffer that is not updating the display with a part of the video buffer that is updating the display, upon determining that the P number of video processing pipelines has completed processing the decoded frame for each of the designated number of the N number of video channels.

18. The method of claim 14, wherein performing the following for each of the designated number of the N number of video channels further comprises scaling the decoded frame based on the image size and the designated number of the N number of video channels.

19. A system for displaying video data from a designated number of N number of video channels on a video display terminal, the system comprising:
an N number of video sources, wherein each of the N number of video sources is to generate video data in a video channel of the N number of video channels; and
a video logic comprising:
an N number of video decoders, wherein each of the N number of video decoders is to receive the video data from one of the N number of video channels and to decode the video data; and
a P number of video processing pipelines coupled to the N number of video decoders through a switch network, the switch network configured to connect any of the outputs from the N number of video decoders to any of the inputs into the P number of video processing pipelines, wherein one of the P number of video processing pipelines is to process the decoded video data from one of the N number of video decoders.

20. The system of claim 19, wherein the video logic further comprises an image size/location logic to receive a control input for a size and a location of a window in the video display terminal and the designated number of the N number of video channels to display in the window, wherein the image size/location logic is to determine a location in the window and a size of a part of the window for display for the video data for each of the designated number of video channels.

21. The system of claim 20, wherein the video logic further comprises an N number of scalers, wherein each of the N number of scalers is to scale the decoded video data from one of the N number of video channels based on the size of the part of the window determined by the image size/location logic.

22. The system of claim 19, wherein P is less than N and wherein the video logic further comprises a display/control logic to control an order of processing of the decoded video data in the designated number of N number of video channels by the P number of video processing pipelines.

23. The system of claim 19, wherein the one of the P number of video processing pipelines is to execute a video fail operation if the one of the N number of video decoders does not lock onto the video data from the one of the N number of video channels after a predetermined time.

24. The system of claim 23, wherein the video fail operation comprises an output of a blacked out frame overlaid with a descriptive text to indicate video failure for the one of the N number of video channels.

25. The system of claim 23, wherein the video fail operation comprises an output of a previous image for the one of the N number of video channels overlaid with a descriptive text to indicate video failure.

26. The system of claim 19, wherein the video data is analog video data.

27. The system of claim 19, wherein the video logic further comprises a write multiplexer coupled to the P number of video processing pipelines, wherein the write multiplexer is to write the processed decoded video data from the P number of video processing pipelines into a video buffer.

28. The system of claim 27, wherein the video logic further comprises a clock multiplier network, the clock multiplier network to control a rate of operation of the write multiplexer.

29. The system of claim 27, wherein the rate of operation is approximately at least P/2.
